(19) United States
(12) Patent Application Publication
(10) Pub. No.: US 2011/0142409 A1
(43) Pub. Date: Jun. 16, 2011

(54) OPTICAL FIBER ADAPTER FIXING ELEMENT

(75) Inventors: HSIN-YI LEE, SANCHONG CITY (TW); CHING-FENG HSIEH, TAIPEI CITY (TW)

(73) Assignee: ASKEY COMPUTER CORP., TAIPEI (TW)

(21) Appl. No.: 12/703,807

(22) Filed: Feb. 11, 2010

(30) Foreign Application Priority Data
Dec. 15, 2009 (TW) 098223514

(51) Int. Cl. G02B 6/00

(52) U.S. Cl. 385/139

(57) ABSTRACT

An optical fiber adapter fixing element applicable to the coupling of an optical fiber adapter and a panel of an optical fiber communication network apparatus includes a hollow hood having a first coupling portion and a second coupling portion. The hollow hood has an assembling side and an opening side adjacent to each other and having an acute angle there between. The second coupling portion is configured to be coupled to the panel. The optical fiber adapter fixing element does not occupy any space attributable to a circuit board provided in the optical fiber communication network apparatus and protects users against harm which might otherwise occur to the users when the users look directly at laser exposed from the optical fiber adapter.

### CROSS-REFERENCE TO RELATED APPLICATIONS

This non-provisional application claims priority under 35 U.S.C. §119(a) on Patent Application No(s). 098223514 filed in Taiwan, R.O.C. on 15 Dec. 2009, the entire contents of which are hereby incorporated by reference.

### FIELD OF THE INVENTION

The present invention relates to an optical fiber adapter fixing element, and more particularly, to the optical fiber adapter fixing element whereby an optical fiber adapter is coupled to a panel of an optical fiber communication network apparatus.

### BACKGROUND OF THE INVENTION

In general, the framework of a conventional optical fiber communication network apparatus 1 is shown in FIG. 1. As shown in the drawing, the optical fiber communication network apparatus 1 comprises a light-emitting unit 2 and a circuit board 3. The light-emitting unit 2 is disposed on the circuit board 3. The circuit board 3 may be fixed inside of a casing 4. Owing to its aforesaid framework, the optical fiber communication network apparatus 1 is modularized. The modularization of the optical fiber communication network apparatus 1 advantageously allows maintenance, movement, or installation of the optical fiber communication network apparatus 1 to be carried out conveniently.

The aforesaid light-emitting unit 2 is configured to receive or transmit an optical signal and convey, via an optical fiber 6 coupled to an optical coupler 5, the optical signal to the outside of the optical fiber communication network apparatus 1 for communication purposes.

Referring to FIG. 2, the optical fiber communication network apparatus 1 has a panel 7 formed with an opening 9 corresponding in position to and locked to a base-equipped optical fiber adapter 8 on the circuit board 3. However, to work in conjunction with the aforesaid locking means, the circuit board 3 must provide a space for accommodating the base-equipped optical fiber adapter 8.

Referring to FIG. 2, the prior art discloses that high-power laser generated by the light-emitting unit 2 is conveyed out of the optical fiber communication network apparatus 1 for communication purposes by means of the fiber 6, the optical coupler 5, and the base-equipped optical fiber adapter 8. However, as shown in FIG. 2, the configuration of the opening 9 and the optical fiber adapter 8 predisposes the human eye to burn when the human eye looks directly at laser transmitted by the optical coupler 5. Furthermore, an external cable (not shown) connected to the optical fiber communication network apparatus 1 is inserted into the optical fiber adapter 8 and then perpendicularly protrudes out of the panel 7. A user is likely to touch the protruding external cable and thereby damage the optical fiber adapter 8 and the external cable. Also, the external cable is likely to be hit and disconnected from the optical fiber adapter 8, and in consequence the optical fiber communication network apparatus 1 malfunctions.

In conclusion, a conventional base-equipped optical fiber adapter must be accommodated in extra space provided by a circuit board and may pose a potential hazard to users. Also, the conventional way of connecting an optical fiber adapter and an external cable is so unreliable that a slight hit can damage the optical fiber adapter and the external cable or disconnect the external cable from the optical fiber adapter.

### SUMMARY OF THE INVENTION

It is an objective of the present invention to provide an optical fiber adapter fixing element whereby an optical fiber adapter is coupled to a panel of an optical fiber communication network apparatus and rendered the optical fiber adapter safer to use and more reliable when connected to an external cable.

To achieve the above and other objective, the present invention provides an optical fiber adapter fixing element applicable to the coupling of an optical fiber adapter and a panel of an optical fiber communication network apparatus. The panel is at least provided with a first opening. The optical fiber adapter fixing element comprises a hollow hood and a second coupling portion. The hollow hood is configured to fill the first opening and has a coupling side and an opening side. The coupling side and the opening side are adjacent to each other and have an acute included angle there between. The coupling side has a first coupling portion configured to be coupled to the optical fiber adapter. The opening side has a second opening for exposing the optical fiber adapter. The second coupling portion extends laterally from the hollow hood and is configured to be coupled to the panel.

Compared with the prior art, an optical fiber adapter fixing element of the present invention overcomes drawbacks of a conventional base-equipped optical fiber adapter directly fixed to a circuit board. An optical fiber adapter is coupled to a panel of an optical fiber communication network apparatus via the optical fiber adapter fixing element of the present invention rather than directly fixed to the circuit board. Owing to its special coupling mechanism, the optical fiber adapter fixing element protects users from danger which might otherwise arise when users look directly at laser transmitted by the optical coupler connected to the optical fiber adapter fixing element, and prevents damage of the apparatus and communication interruption which might otherwise arise when users inadvertently hit the external cable connected to the optical fiber adapter fixing element.

### BRIEF DESCRIPTION OF THE DRAWINGS

FIG. 1 and FIG. 2 are schematic views of a optical fiber adapter disposed inside an optical fiber communication network apparatus according to the prior art;

FIG. 3-5 are schematic views of an embodiment of an optical fiber adapter fixing element for use with an optical fiber communication network apparatus according to the present invention; and

FIG. 6 is a schematic view of the application of the optical fiber adapter fixing element to an optical fiber communication network apparatus in the embodiment described above according to the present invention.

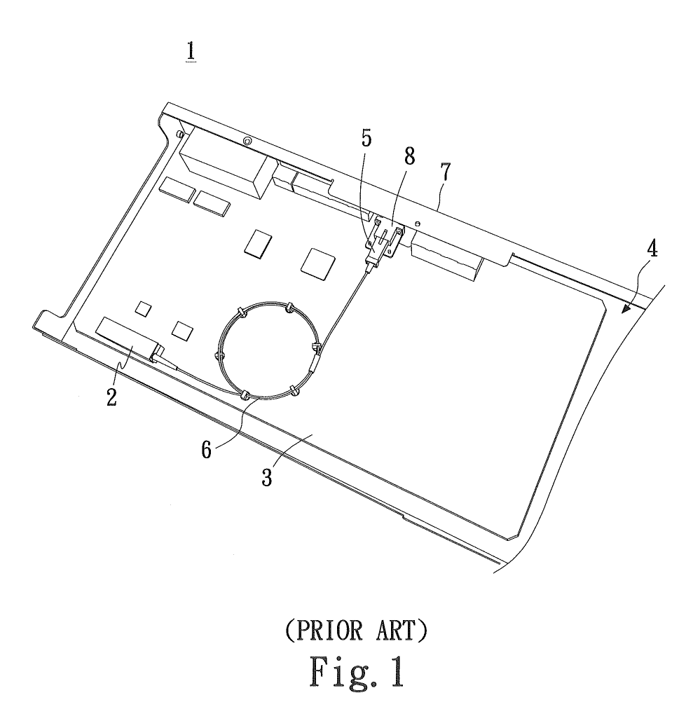

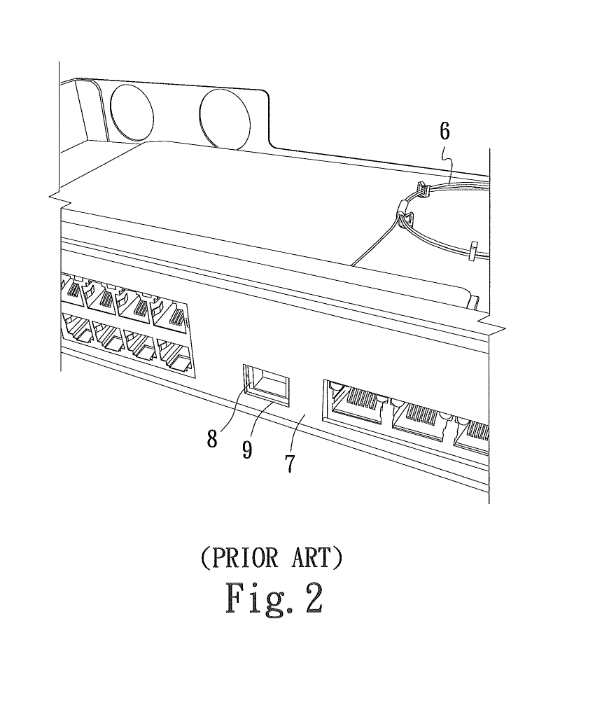

### DETAILED DESCRIPTION OF THE EMBODIMENTS

To enable persons skilled in the art to understand the objectives, features and advantages of the present invention, the present invention are described in detail hereunder and illustrated with embodiments and the appended drawings.

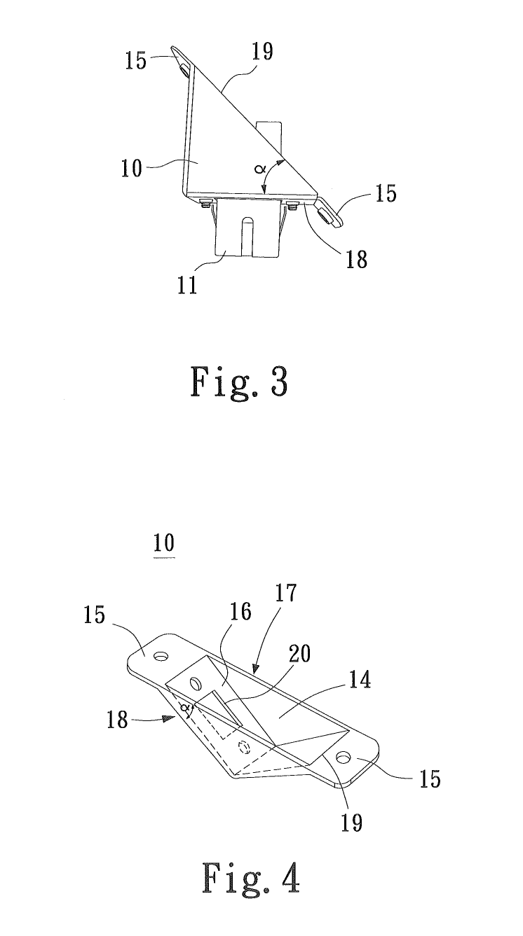

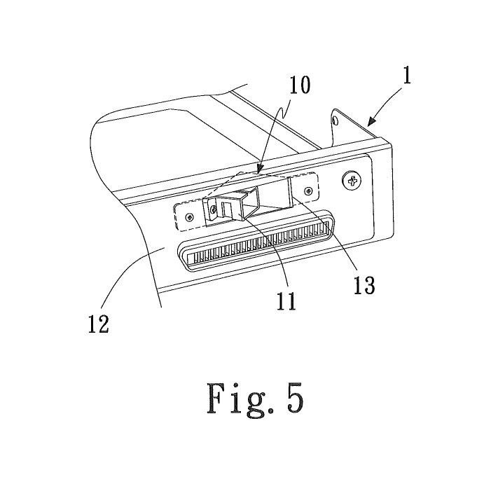

Referring to FIG. 3-5, there are schematic views of an embodiment of an optical fiber adapter fixing element for use with an optical fiber communication network apparatus according to the present invention. As shown in FIG. 3, an optical fiber adapter fixing element 10 is provided and configured to connect to an optical fiber adapter 11 optical fiber. As shown in FIG. 5, the optical fiber adapter fixing element 10 is coupled to a panel 12 of a optical fiber communication network apparatus 1, wherein the panel 12 is provided with a first opening 13. As shown in FIG. 4, the optical fiber adapter fixing element 10 is provided with a hollow hood 14 and a second coupling portion 15. Referring to FIG. 5, after the optical fiber adapter fixing element 10 has been coupled to the panel 12, the first opening 13 is assembled with the hollow hood 14, and the cross-section of the hollow hood 14 is a triangular shape. The hollow hood 14 has an assembling side 16 and an opening side 17. The assembling side 16 and the opening side 17 are adjacent to each other and has an acute angle α formed there between, where a ranges between 30° and 60° and is preferably 45°. Also referring to FIG. 3 and FIG. 4, the assembling side 16 has a first coupling portion 18 designed to be assembled to the optical fiber adapter 11, and the opening side 17 has a second opening 19 from which the optical fiber adapter 11 is exposed. The first coupling portion 18 is provided with two screw holes corresponding in positions to the screw holes on the optical fiber adapter 11 for screwing and coupling. Referring to FIG. 4 and FIG. 5, the second coupling portion 15 extends laterally from the hollow hood 14 and is configured to be coupled to the panel 12, and the second coupling portion 15 is provided with a screw hole corresponding in position to another screw hole on the panel 12 for screwing and coupling.

Returning to FIG. 3 and FIG. 4 for reference, the assembling side 16 of the optical fiber adapter fixing element 10 is provided with a third opening 20 for the penetration by the optical fiber adapter 11, and wherein the first coupling portion 18 is provided with two screw holes which are formed on the assembling side 16 and flank the third opening 20. The two screw holes of the first coupling portion 18 provided on the optical fiber adapter fixing element 10 is assembled and screwed with screw holes of the optical fiber adapter 11.

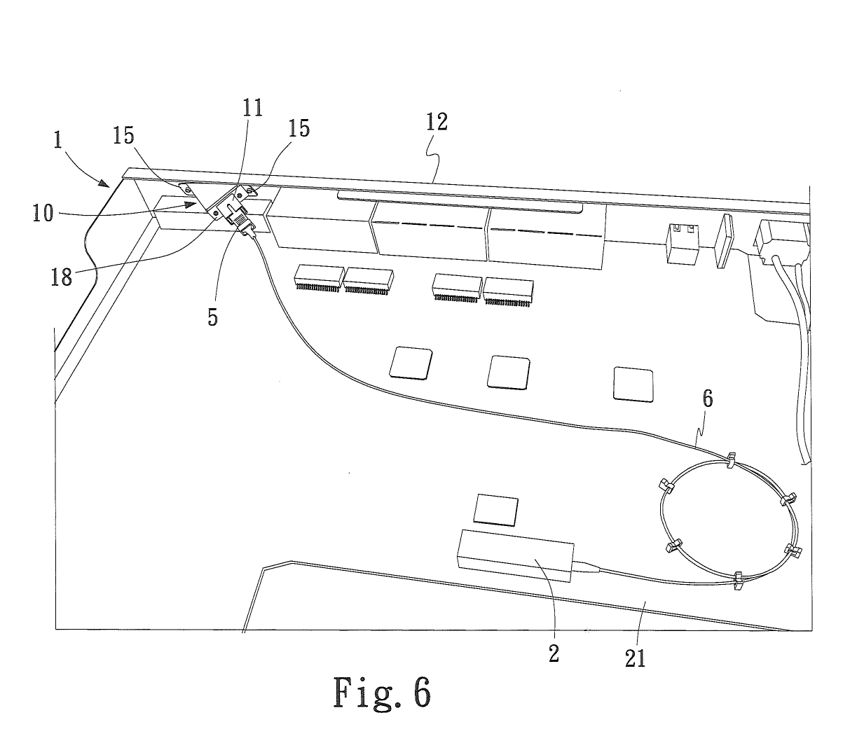

Referring to FIG. 6, there is a schematic view of the application of the optical fiber adapter fixing element to an optical fiber communication network apparatus in the aforementioned embodiment according to the present invention. As shown in the drawing, the optical fiber adapter fixing element 10 of the present invention is not disposed on a circuit board 21 in the optical fiber communication network apparatus 1; instead, the optical fiber adapter fixing element 10 of the present invention is coupled to the panel 12 of the optical fiber communication network apparatus 1. Preferably, the optical fiber adapter fixing element 10 is coupled to the panel 12 through the second coupling portion 15, wherein the optical fiber adapter fixing element 10 is provided with the third opening 20 (as shown in FIG. 4) for the penetration by the optical fiber adapter 11. The optical fiber adapter 11 is screwed to the first coupling portion 18 by means of two screw holes which flank the first coupling portion 18. It is worth noting that the optical fiber adapter fixing element 10 has the assembling side 16 and the opening side 17 (described in the embodiments above) which are adjacent to each other and have an acute i angle there between. After the optical fiber adapter 11 has been screwed and fixed to the first coupling portion 18, the optical fiber adapter 11 is exposed from the second opening 19 that corresponds to the opening side 17. Hence, laser from the light-emitting unit 2 disposed on the circuit board 21 is conveyed to the optical coupler 5 by the optical fiber 6. The optical coupler 5 is then applied and disposed to the optical fiber adapter 11. It is worth noting that the aforesaid optical fiber adapter 11 is coupled to the panel 12 of the optical fiber communication network apparatus 1 through the optical fiber adapter fixing element 10.

Compared with the prior art, the present invention provides an optical fiber adapter fixing element which prevents an optical fiber adapter from occupying any extra space otherwise attributable to a circuit board provided in an optical fiber communication network apparatus. Owing it its special coupling mechanism, the optical fiber adapter fixing element protects users from danger which might otherwise arise when users look at laser emitted by a light-emitting unit and transmitted through the optical fiber adapter, and prevents damage of the apparatus and communication interruption which might otherwise arise when users inadvertently hit an external cable connected to the optical fiber adapter fixing element.

The foregoing descriptions of the preferable embodiments are provided to illustrate and disclose the features and functions of the present invention; however, those skilled in the art should understand that these embodiments are not intended to be restrictive of the scope of the present invention. It should be noted that equivalent modifications and variations can be made according to the spirit and principle in the disclosure of the present invention and still fall within the scope of the invention as set forth in the appended claims. Hence, the scope of protection for the present invention shall be defined by the appended claims.

What is claimed is:

1. A optical fiber adapter fixing element, applicable to coupling of a optical fiber adapter and a panel of an optical fiber communication network apparatus, the panel provided with a first opening, and the optical fiber adapter fixing element comprising:
a hollow hood for filling the first opening and having an assembling side and an opening side adjacent to each other and having an acute angle there between, the assembling side having a first coupling portion configured coupled to the optical fiber adapter, and the opening side having a second opening for exposing optical fiber adapter; and
a second coupling portion extending laterally from the hollow hood and configured to be coupled to the panel.

2. The optical fiber adapter fixing element of claim 1, wherein the acute angle ranges between 30° and 60°.

3. The optical fiber adapter fixing element of claim 1, wherein the acute angle is 45°.

4. The optical fiber adapter fixing element of claim 1, wherein the first coupling portion is provided with two screw holes.

5. The optical fiber adapter fixing element of claim 1, wherein the assembling side is provided with a third opening for penetration by the optical fiber adapter, and the first coupling portion is provided with two screw holes provided on the assembling side and flanking the third opening.

6. The optical fiber adapter fixing element of claim 1, wherein the hollow hood has a triangular cross-section.

7. The optical fiber adapter fixing element of claim 1, wherein the second coupling portion is provided with a screw hole.
